(19) United States
(12) Patent Application Publication
(10) Pub. No.: US 2017/0115373 A1
(43) Pub. Date: Apr. 27, 2017

(54) A PHOTOGRAPHIC OBJECT DETECTION SYSTEM AND A METHOD AS WELL AS A POSITION DETECTION APPARATUS AND A TRANSPONDER, THEREFORE

(71) Applicant: Great Innovations Stockholm AB, Saltsjobaden (SE)

(72) Inventors: Karl Lindstrom, Saltsjobaden (SE); Kristoffer Nilsson, Stockholm (SE); Kjell Wallin, Gavle (SE)

(21) Appl. No.: 15/127,817

(22) PCT Filed: Mar. 31, 2015
(86) PCT No.: PCT/SE2015/050395

§ 371 Date: Sep. 21, 2016

(30) Foreign Application Priority Data
Apr. 1, 2014 (SE) 1450392-4

(51) Int. Cl. G01S 5/02; G03B 17/06; G06T 7/70; G01S 13/79; G01S 5/00

(52) U.S. Cl. CPC G01S 5/0263; G01S 13/79; G01S 5/0284; G01S 5/0072; G06T 7/70; G03B 17/06; G03B 2206/00

(57) ABSTRACT

The present invention relates to a system, a transponder, a position detection apparatus, and a method for a photographic object detection system. The method comprises providing a position detection apparatus connectable to an image capturing apparatus; and providing a transponder having an identity. The method further comprises determining a position of the transponder relative the position detection apparatus, generating transponder data comprising the identity of the transponder, and generating a signal indicative of the position of the transponder relative an image frame of the image capturing apparatus.

### TECHNICAL FIELD

The invention relates to an object detection system. In particular the invention relates to a photographic object detection system, a method, a position detection apparatus and a transponder, therefore.

### BACKGROUND

A common problem during outdoor activities is that during times when certain activities are performed there is no possibility to instruct a photographer to capture images of the activity. For example during downhill skiing, mountain biking and during similar activities. The problem is even larger if the photographer is unknown to the person that wants images of said activities.

A recurrent problem in photography is that there is no photographer available when one is needed. The usual way to manage this is by acting as the photographer yourself. There are numerous drawbacks with this, for example, you will never be captured on a picture yourself, you will have to interrupt your current activity when a picture is to be taken, the scene you first wanted to capture is no longer available by the time you have your camera ready, and people in the scene will lose their natural look. Thus, the best pictures of you and your friends will only be captured by hiring a photographer. However, hiring a dedicated photographer is very expensive.

A known solution that might be used to solve at least a part of the above stated problem is to utilize image recognition, but for this technique to be successful reference information about the image object is needed. This solution is not viable if the image object is unknown to the photographer.

Another solution known in the art is disclosed in U.S. Pat. No. 7,492,262. This solution involves a camera with a directional antenna system and a corresponding transceiver. The photographic object is equipped with a RFID tag being configured to be activated upon receiving its identity. The camera with the directional antenna system broadcast the identity of the RFID tag searched for with a directed antenna beam, when the RFID tag is subjected to radio waves indicating the ID of the RFID tag, the RFID tag responds to the broadcast and the camera with the directional antenna system takes the bearing of the RFID tag by means of the directional antenna system.

The system of U.S. Pat. No. 7,492,262 also needs ‘a priori’ information about the identity of the RFID tag and does not solve the problem if the photographer and the image object are unknown to each other.

Furthermore, this system cannot precisely determine the distance from the camera to the RFID tag. A coarse estimate of the distance can be obtained by means of measuring path-loss. This solution enables automatic object following. However, this solution is limited in several ways. Firstly, the distance to the RFID tag is not precisely measured with a measurement of path-loss. Secondly, the proposed system allows only visual locating services for one RFID tag at a time. Hence, multiple object following is not possible. Thirdly, the proposed system does not allow precise measurements of the position due to the directional resolution of the directed antenna beam. Last but not least, the narrow antenna beam makes it very hard for the photographer to find the bearing of the RFID tag with the directional antenna system.

Therefore, it exist a need for an improved solution that obviates the above mentioned limitations and drawbacks.

### SUMMARY

In view of the problems of known photographic detection methods, the present invention aims to provide an improved photographic detection method, and an improved system. As well as an improved transponder and an improved position detection apparatus.

In accordance with an embodiment of the present invention a method for a photographic object detection system is provided, the method comprises providing a position detection apparatus connectable to an image capturing apparatus. The method further comprises providing a transponder having an identity, and determining a position of the transponder relative the position detection apparatus. The method further comprises generating transponder data comprising the identity of the transponder; and generating a signal indicative of the position of the transponder relative an image frame of the image capturing apparatus.

In accordance with an embodiment of the present invention a photographic object detection system is provided, the system comprises a position detection apparatus connectable to an image capturing apparatus, and a transponder having an identity. The position detection apparatus comprises means for determining a position of the transponder relative the position detection apparatus, means for generating transponder data indicative of the identity of the transponder. The position detection apparatus further comprises means for generating a signal indicative of the position of the transponder relative an image frame of the image capturing apparatus.

In accordance with an embodiment of the present invention a position detection apparatus for a photographic object detection system is provided. The position detection apparatus comprises means for connection of the position detection apparatus to a connectable image capturing apparatus, means for determining a position of a transponder relative the position detection apparatus. The position detection apparatus further comprises means for generating transponder data indicative of the identity of the transponder, and means for generating a signal indicative of the position of the transponder relative an image frame of the image capturing apparatus.

In accordance with an embodiment of the present invention a transponder for a photographic object detection system is provided. The transponder comprises a second receiving means, a second transmitting means, and a second processing means. The second processing means comprises an identity of the transponder, means for receiving a pseudo number sequence, means for modulation of the received pseudo number sequence, and means for sending the modulated pseudo number sequence.

An advantage of certain embodiments is that an improved photographic object detection system is provided.

Another advantage of certain embodiments is that multiple transponders can be localized and identified.

Yet another advantage of certain embodiments is that a priori information about the identities of the transponders no longer is necessary.

### BRIEF DESCRIPTION OF THE DRAWINGS

Embodiments of the invention will now be described, by way of example only, with reference to the accompanying drawings in which:

FIG. 1 shows a exemplary scenario of an embodiment of the present invention;

FIG. 2 shows a camera with a position detection apparatus;

FIG. 3 shows an illustration of determining the position of a transponder position in an image frame of the camera;

FIG. 4 is a flowchart illustrating a method for a photographic object detection system according to an embodiment of the present invention;

FIG. 5 shows a position detection apparatus and a transponder according to an embodiment of the present invention;

FIG. 6 is a flowchart illustrating a method according to an embodiment of the present invention;

FIG. 7 is a schematic block diagram illustrating a transponder according to the present invention;

FIG. 8 is an illustration of an antenna arrangement according to an embodiment of the present invention; and

FIG. 9 is an exemplary scenario for an embodiment of the invention.

### DETAILED DESCRIPTION

In the following, different aspects will be described in more detail with reference to certain embodiments and to accompanying drawings. For purpose of explanation and not limitation, specific details are set forth, such as particular scenarios and techniques, in order to provide a thorough understanding of the different embodiments. However, other embodiments that depart from these specific details may also exist.

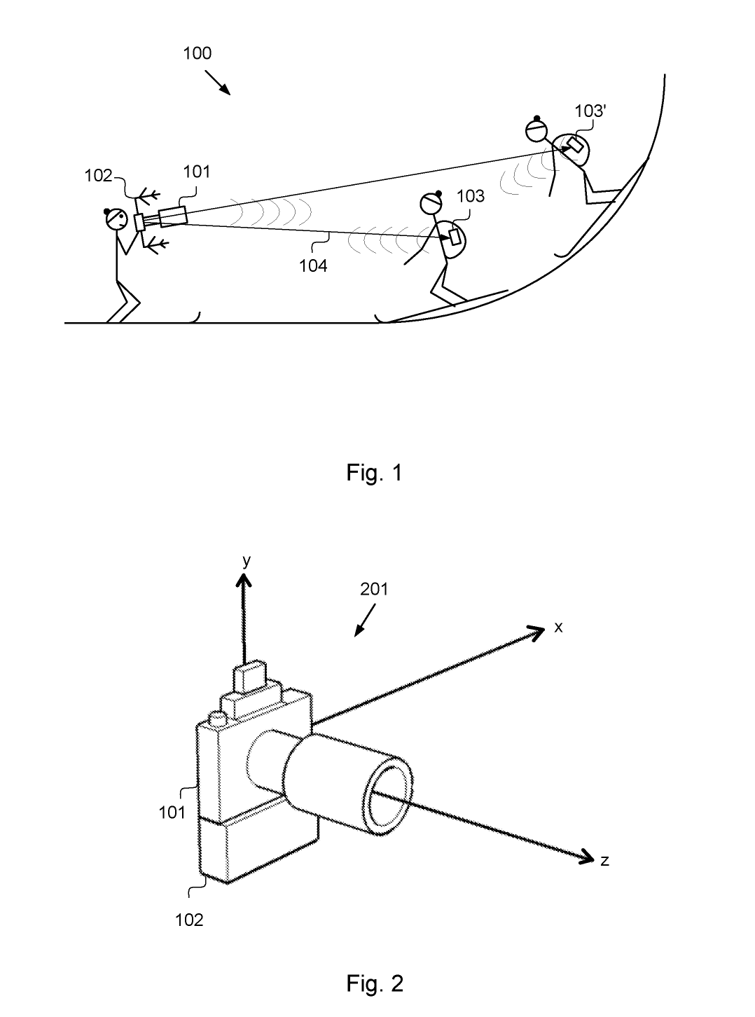

The basic concept of the invention will now be described with reference made to FIG. 1. In this figure a photographer is illustrated with a camera 101 and a position detection apparatus 102 connected thereto. The camera 101 is directed toward a downhill slope in which two skiers are skiing. The first skier carries a first transponder 103 and the second skier carries a second transponder 103′. The position detection apparatus 102 is configured to detect the position of the first skier and the second skier by means of locating the first transponder 103 and the second transponder 103′, respectively.

In one embodiment the first transponder 103 and the second transponder 103′ are equipped with means for determining the position by means of an external positioning system, such as for example Global Positioning System (GPS). The transponder transmits its position together with an identifier to the position detection apparatus 102. The position detection apparatus then calculates the position of the transponder relative the position detection apparatus.

Now, with reference made to FIG. 2 an embodiment of an image capturing apparatus and a position detection apparatus are disclosed. In this figure the camera 101 is illustrated with a connected position detection apparatus 102. In this embodiment the position detection apparatus 102 is arranged in a separate housing and connected using a piggy-back configuration to the camera 101. The position detection apparatus 102 is connected to the camera 101 by means of standard connection means for auxiliary equipment. This connection allows the position detection apparatus 102 to communicate with the camera 101 using a standardized bus connection to the camera 101.

In another embodiment is the position detection apparatus integrated in the housing of the camera 101 and connected to either, the standardized bus, or directly to the microprocessor of the camera.

A coordinate system 201 is introduced in FIG. 2. This coordinate system 201 is a right-hand system with origo at a distance from an image frame of the camera 101. In one embodiment is origo of the right-hand system in the image frame. The x and y axis forms a plane that is parallel with the image frame. The image frame is configured to receive the image from the optics of the camera 101. If the camera is a digital camera or digital video camera the image frame corresponds to the image sensor area.

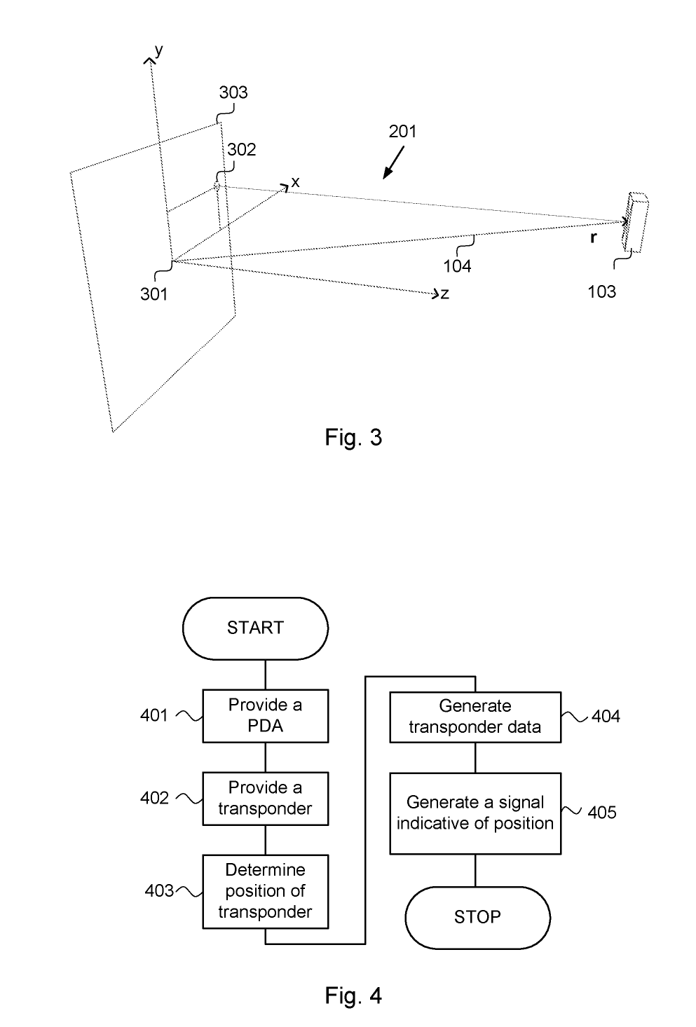

This coordinate system is further elucidated in FIG. 3. In this embodiment the origo 301 of the coordinate system is in the image frame 303. From origo 301 a vector 104 to the transponder 103 is constructed. This vector 104 may be used to project the position of the transponder to the image frame 303. Thus, by receiving the position of the transponder 103 an image can be tagged with information about the identity of the transponder 103 in an image point 302.

Furthermore, the above outlined method can further be elucidated with reference made to FIG. 4 that illustrates an embodiment of the method using a flowchart, wherein:
401: Provide a position detection apparatus 102 connectable to an image capturing apparatus 101. This position detection apparatus can be a separate device configured to be connected to the image capturing apparatus 101 by means of an expansion port. In another embodiment may the position detection apparatus be integrated into the image capturing apparatus 101.
402: Provide a transponder 103 having an identity. The identity may in one embodiment be a unique number of for example 32 bits.
403: Determining a position of the transponder 103 relative the position detection apparatus 102. The transponder may in one embodiment comprise a means for external positioning such as for example a GPS. The transponder 103 may also be configured to transmit its position to the position detection apparatus 102.
In one embodiment the transponder sends its position to the position detection apparatus, the position detection apparatus may also need to determine its position and direction relative the transponder.
404: Generating transponder data comprising the identity of the transponder 103. In one embodiment transponder data comprises information about the identity of the transponder as well as the position thereof.
405: Generating a signal indicative of the position of the transponder relative an image frame of the image capturing apparatus. In order to provide feedback to the photographer a signal is generated that is indicative of the position of the transponder relative the image frame of the image capturing apparatus. This signal can in one embodiment be a sound alert signal indicating that the transponder is within the image frame of the image capturing apparatus. The signal may in one embodiment be a visual signal in a viewfinder of the image capturing apparatus. This signal may also indicate the position of the transponder in the viewfinder of the image capturing apparatus. These examples of signals are not exhaustive but rather mentioned as examples of embodiments.

Hence, from the above description in connection with the flowchart in FIG. 4 it is clear that the technical problem of determining a position of a transponder relative a position detection apparatus can be attained by means of an external positioning system such as GPS. The inherent uncertainty of the position detected by the GPS solution can in some applications be a limiting factor. The GPS based solution is also rather demanding in terms of power and computation. Thus, a transponder that utilizes a GPS based location service becomes rather power hungry.

As a solution to this problem associated with external positioning systems another embodiment of a photographic object detection system and a method are disclosed below.

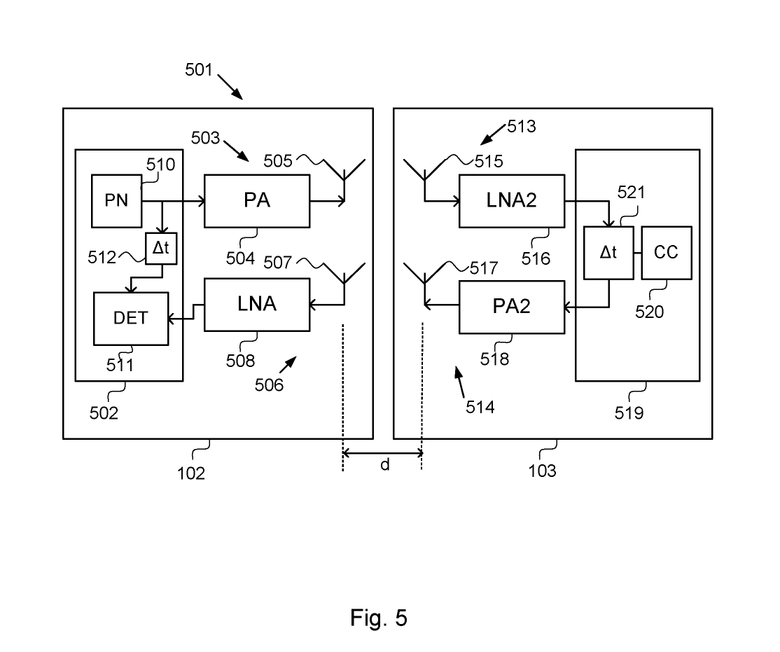

In FIG. 5 is an embodiment of a photographic object detection system 501 disclosed. In this figure only the position detection apparatus 102 and the transponder 103 is illustrated. The transponder 103 and the position detection apparatus are separated by a distance d. In a typical scenario the distance may be in the interval from 5 m to 100 m.

The position detection apparatus 102 comprises a first processing means 502, which in one embodiment may be a field programmable gate array (FPGA) or a microcontroller. The position detection apparatus 102 further comprises a first transmitting means 503, which in one embodiment may comprise a transmitting antenna 505 connected to the first processing means 502 via a power amplifier (PA) 504. The position detection apparatus 102 further comprises a first receiving means 506, which in one embodiment may comprise a receiving antenna 507 connected to the first processing means 502 via a low noise amplifier (LNA) 508.

The first processing means 502 further comprises a pseudo number (PN) generator 103 provided to generate a PN sequence of a predetermined length. This pseudo number generator may in one embodiment generate a pseudo random binary sequence (PRBS) but other sequences may be generated in other embodiments, such as Gold code for example. The generated PN sequence is relayed from the first processing means 502 to the PA 504 of the first transmitting means 503, and to a detection means 511 via a delay means 512.

Furthermore, to the right in FIG. 5 an embodiment of a transponder 103 is disclosed. The transponder 103 comprises a second receiving means 513 having a second receiving antenna 515 connected to a second low noise amplifier (LNA2) 516. The transponder 103 further comprises a second transmitting means 514. The second transmitting means 514 may in one embodiment have a second transmitting antenna 517 connected to a second power amplifier (PA2) 518. The transponder 103 further comprises a second processing means 519 being connected to the PA2 518 and to the LNA2 516.

The second processing means 519 comprises a delay circuit 521 with the input thereof connected to the output of the LNA2 516, the delayed output from the delay circuit 521 is connected to the PA2 518. The amount of delay is controlled by means of a control circuit (CC) 100.

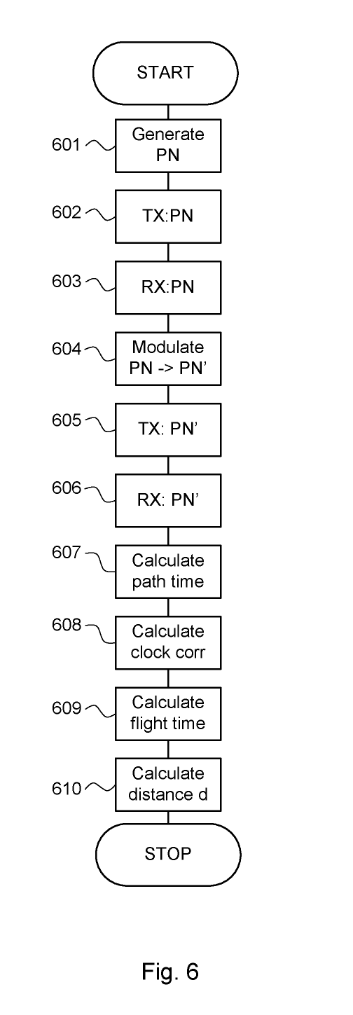

The operation of the embodiment of a system according to FIG. 5 will now be disclosed with reference made to FIG. 6 illustrating an embodiment of the inventive method.
601: A pseudo number sequence (PN-sequence) of a PRBS type is generated by means of the PN 510 of the first processing means 502. In one embodiment, may the length of the sequence be 32767 bits before the sequence repeat it self.
602: Transmitting the pseudo number sequence by means of the first transmitting means 503. The PN-sequence is relayed from the PN 510 to the first transmitting antenna 505 via PA 504. The PN-sequence travels a distance d with the speed of light before reaching the transponder 103.
603: The transponder 103 receives the PN sequence by means of the second receiving means 513. The received PN-sequence is amplified by LNA2 516 and relayed to the second processing means 519.
604: The received PN-sequence is modulated by means of delaying the received pseudo number sequence a predetermined number of clock cycles from a group of at least two predetermined number of clock cycles, by means of the second processing means 519. This modulation will be described in more detail in the following.

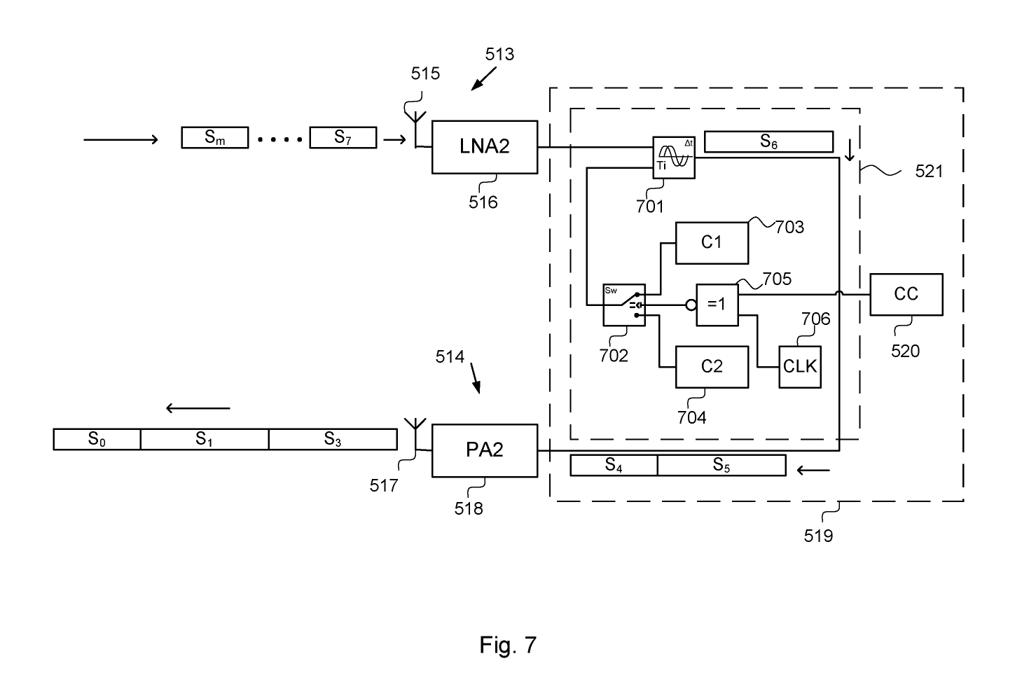

In order to describe the modulation of the PN-sequence reference is now made to FIG. 7. In FIG. 7 is a number of PN-sequences S₀-Sₘ illustrated. The length of each of these PN-sequences will in reality be much longer than the length illustrated in this embodiment. The PN-sequence is received by means of the second receiving antenna 515 and amplified by LNA2 516. In one embodiment is the received PN-sequence converted to a digital signal by means of an analogue to digital converter of the second processing means 519. The received PN-sequence is relayed to a variable delay circuit 701. The output from this variable delay circuit 701 is relayed to the PA2 518 and transmitted by means of the second transmitting antenna 517. The modulation of the received PN-sequence is performed by the variable delay circuit 701. The amount of delay is controlled by means of a switching element 702, that in this embodiment selects the amount of delay from two predetermined numbers of clock cycles C1 703 or C2 704, given as a number of clock cycles of the transponder 103. The switching of the switching element 702 is controlled by means of an output from an exclusive NOR circuit (XNOR) 705. The input signals to the XNOR 705 are a sequence clock signal from a sequence clock 706 and a data signal from a control circuit 520.

In one embodiment is the frequency of the sequence clock 706 selected such that a full PN-sequence of for example 32767 bits is transferred during a half clock period of the sequence clock 706.

The data signal from the control circuit 520 is a bit stream that in one embodiment has a frequency of half the clock frequency of the sequence clock 706. Both the bit stream frequency and the frequency of the sequence clock 706 is a multiple of the clock frequency of the second processing means 519.

By introducing the delay values of the variable delay circuit 702 to the stream of PN-sequences the bit stream from the control circuit 520 can be transferred by means of the PN-sequences. Each bit from the bit stream may in one embodiment be transferred by means of two PN-sequences by means of a differential modulation.

Now with reference made to FIG. 6 again, the embodiment of the method further comprises.
605: Transmitting the modulated pseudo number sequence by means of the second transmitting means 514.
606: Receiving the modulated pseudo number sequence by means of the first receiving means 506. In one embodiment comprises the first receiving means 506 an analogue to digital converter, whereby the received modulated pseudo number sequence is digitized.
607: Calculating a round trip travel time of the pseudo number sequence, by means of delaying and correlating the generated pseudo number sequence with the received modulated pseudo number sequence, wherein the delay time corresponds to the round trip travel time, by means of the first processing means (102). The generated PN-sequence is relayed to a detector 511 via a delay means 512 and stored in a register. The received modulated PN-sequence is also relayed to the detector 511. In one embodiment the detector 511 is configured to receive a modulated PN-sequence of twice the length of the generated PN-sequence from the PN generator. By means of adjusting the delay time of the delay means 512 and correlating the received modulated PN-sequence with the delayed generated PN-sequence a correlation signal can be obtained. Upon detection of a maximum value of the correlation signal, the corresponding adjusted delay time of the delay means 512 corresponds to the round trip travel time for the pseudo number sequence.
608: Calculating a clock correction factor for the transponder 103 using the received modulated pseudo number sequence, by means of the first processing means 502. The clock correction factor is detected by means of triggering a counter of the first processing means upon detection of a correlation signal maximum. The counter is configured to count the number of clock pulses of the first processing means 502 between two correlation signal maximum. The first processing means 502 is configured to comprise information about the predetermined delays C1 703 and C2 704 of the second processing means 519. Hence, by using the counted number of clock pulses in the first processing means 502 and the information about the predetermined delays C1 and C2 in the second processing means 519, the first processing means 502 is capable of calculating a clock correction factor that can be used to adjust the predetermined delays C1 and C2 of the second processing means 519 to corresponding delays measured by means of the first processing means 502. Hereby, a clock correction factor is provided that can be used to translate times measured by means of the second processing means to times measured by means of the first processing means 502.
609: Calculating a flight time of the pseudo number sequence between the position detection apparatus and the transponder by means of the round trip travel time, the clock correction factor, and the predetermined number of clock cycles of the transponder, by means of the first processing means 502;
610: Calculating the distance between said position detection apparatus and said transponder by means of the flight time, by means of the first processing means 502.

Thus, by means of the above disclosed method a precise measurement of a distance between an antenna of the position detection apparatus and an antenna of the transponder can be obtained.

By providing the first receiving means 506 with at least three receiving antennas corresponding distances to the transponder are easily obtained, and from these distances a position of the transponder can be calculated using simple geometrical calculations.

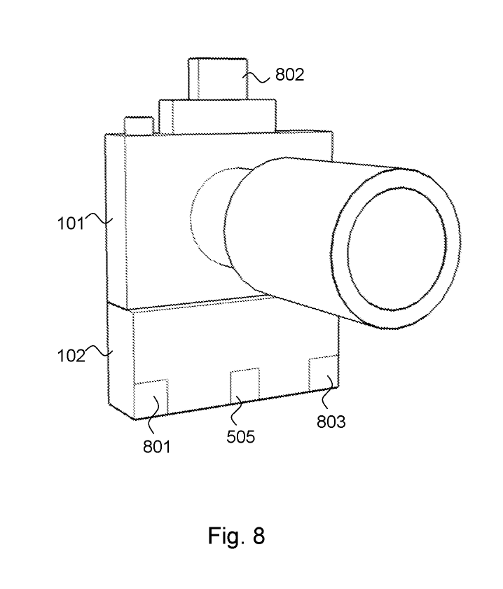

An embodiment of a position detection apparatus 102 having a first receiving means with three receiving antennas 801, 802, and 803 is illustrated in FIG. 8. The position of the three receiving antennas is to a certain degree arbitrary. In this embodiment the antennas are spaced in a plane parallel with the image frame of the image capturing apparatus 101. In this embodiment the first transmitting antenna 505 is arranged in the same plane as the three receiving antennas.

By calculating, for each of the at least three receiving antennas 801, 802, and 803, a distance using said flight time, and by using these distances in a geometrical formula the position of the transponder is easily calculated with a good accuracy.

In the following two exemplary scenarios of the system will be disclosed.

In FIG. 1 a first skier carrying an activated transponder 103 skies in a downhill slope together with a second skier carrying a second activated transponder 103′. By carrying activated transponders the skiers indicate that they are interested in being captured on images and/or video.

In the figure a photographer is present carrying an image capturing apparatus 101, such as for example a digital camera or a video apparatus, with a position detection apparatus 102 connected thereto. When the photographer aims his image capturing apparatus 101 in the direction of the downhill slope, the position detection apparatus 102 will generate a signal indicative of the position of the transponders relative an image frame of the image capturing apparatus. This signal may for example be a visual signal in the viewfinder of the image capturing apparatus 101, but it can also be an audible signal that provides an audible guidance for directing the image capturing apparatus 101. When the photographer activates the trigger of the image capturing apparatus 101 an image tag comprising transponder data for at least one transponder within the image frame is generated and stored together with the image data. This image tag may in one embodiment be stored in a computer readable memory, such as for example a SD-card etc. in either the position detection apparatus 102 or the image capturing apparatus 101. The image tag is stored in such a way that the associated image easily can be retrieved.

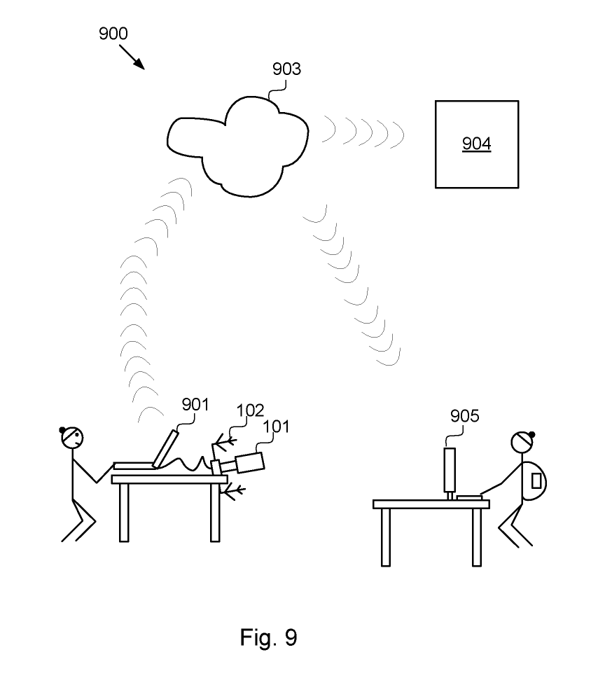

At a later time illustrated in FIG. 9 the photographer connects the image capturing apparatus 101 and the position detection apparatus 102 to a computer 901. This computer 901 is adapted to communicate with a remote server 904 via internet 903. This communication comprises uploading said captured image and image tag to the remote server 904. On the remote server information about the transponder identity and the corresponding user is available by means of for example a database. When the image and the image tag are uploaded to the remote server, the user corresponding to the image tag is notified by means of a message sent from the remote server 904 to a user computer 905. The user can then preview the picture of him skiing, and if he decides that he wants the picture it is possible to purchase the picture from the remote server 904.

In one embodiment the user computer 905 is a mobile device, such as a smartphone.

The message sent from the remote server 904 to the user may in one embodiment be a SMS message or a notification by means of a social media.

If several users are associated with the image tag each user is notified about the image.

In one embodiment, the first receiving means 506 and the second receiving means 5013 comprises broadband antennas.

In one embodiment is the broadband antenna a Vivaldi antenna.

In yet another preferred embodiment the first processing means 502 is a field programmable gate array (FPGA).

In yet another embodiment, the first processing means 502 and the second processing means 519 comprises analogue to digital converters.

In yet another embodiment is the system configured for impulse radio.

In yet another embodiment is the transponder integrated in a mobile device such as a mobile phone.

In the above disclosed embodiments is a baseband modulated solution disclosed but for the person skilled in the art it is a small effort to introduce mixers and oscillators etc. to provide a solution operable at a desired frequency.

1. Method for a photographic object detection system comprising:
providing a position detection apparatus connectable to an image capturing apparatus; and
providing a transponder having an identity;
determining a position of the transponder relative the position detection apparatus;
generating transponder data comprising the identity of the transponder; and
generating a signal indicative of the position of the transponder relative an image frame of the image capturing apparatus.

2. Method according to claim 1, wherein the step of determining the position of the transponder comprises:
determining the position of the transponder by means of an external positioning system.

3. Method according to claim 1, wherein:
the position detection apparatus, further comprises:
a first processing means;
a first transmitting means;
a first receiving means; and
the transponder further comprises:
a second processing means;
a second receiving means;
a second transmitting means;
the method further comprises:
generating a pseudo number sequence by means of the first processing means;
transmitting the pseudo number sequence by means of the first transmitting means;
receiving the pseudo number sequence by means of the second receiving means;
modulate the received pseudo number sequence by means of the second processing means;
transmitting the modulated pseudo number sequence by means of the second transmitting means;
receiving the modulated pseudo number sequence by means of the first receiving means;
calculating a path time of the pseudo number sequence by means of the first processing means;
calculating a clock correction factor for the transponder using the received modulated pseudo number sequence, by means of the first processing means;
calculating a flight time of the pseudo number sequence between the position detection apparatus and the transponder by means of the path time, the clock correction factor, and a predetermined number of clock cycles of the transponder, by means of the first processing means;
calculating a position of said transponder by means of the flight time, by means of the first processing means.

4. Method according to claim 3, wherein the modulation comprises delaying the received pseudo number sequence a predetermined number of clock cycles from a group of at least two predetermined number of clock cycles.

5. Method according to claim 4, wherein the modulation of the received pseudo number sequence further comprises:
a differential modulation by means of the at least two predetermined number of clock cycles in such a way that information from the transponder is encoded within the modulated pseudo number sequence.

6. Method according to claim 3, wherein the detection comprises delaying and correlating the generated pseudo number sequence with the received modulated pseudo number sequence, wherein the delay time corresponds to the round trip travel time.

7. Method according to claim 3, wherein the detection of the clock correction factor further comprises:
decoding the information from the transponder by means of decoding the time delay of the modulated pseudo number sequence.

8-13. (canceled)

14. A photographic object detection system, comprising:
a position detection apparatus connectable to an image capturing apparatus;
a transponder having an identity;
wherein the position detection apparatus comprises:
means for determining a position of the transponder relative the position detection apparatus;
means for generating transponder data indicative of the identity of the transponder; and
means for generating a signal indicative of the position of the transponder relative an image frame of the image capturing apparatus.

15. A photographic object detection system according to claim 14, wherein the transponder comprises means for determining the position of the transponder by means of an external positioning system.

16. A photographic object detection system according to claim 14, wherein the position detection apparatus, further comprises:
a first transmitting means;
a first receiving means;
a first processing means, comprising:
means for generating a pseudo number sequence;
means for decoding the modulated pseudo number sequence;
means for detecting a round trip travel time of the pseudo number sequence,
means for detecting a clock correction factor of the transponder by means of the predetermined delay time of the received modulated pseudo number sequence;
means for calculating a flight time of the pseudo number sequence between the position detection apparatus and a transponder by means of the round trip travel time, the clock correction factor, and the predetermined delay time of the transponder;
means for calculating the position of said transponder by means of the flight time; and
the transponder further comprises:
a second receiving means;
a second transmitting means;
a second processing means, comprising:
means for receiving the pseudo number sequence;
means for modulation of the received pseudo number sequence forming the modulated pseudo number sequence,
means for sending the modulated pseudo number sequence.

17. A photographic object detection system according to claim 16, wherein the means for modulation of the received pseudo number sequence further comprises means adapted to modulate the received pseudo number sequence by means of delaying the received pseudo number sequence a predetermined delay time from a group of at least two predetermined delay times.

18. A photographic object detection system according to claim 16, wherein the means for modulation of the received pseudo number sequence further comprises:
means for a differential modulation by means of the at least two predetermined delay times in such a way that information about the identifier of the transponder is encoded within the modulated pseudo number sequence.

19. A photographic object detection system according to claim 16, wherein the means for detection of the received pseudo number sequence further comprises means for delaying and correlating the generated pseudo number sequence with the received modulated pseudo number sequence, wherein the delay time corresponds to the path time.

20. A transponder for a photographic object detection system, comprising:
a second receiving means;
a second transmitting means;
a second processing means, comprising:
an identity;
means for receiving a pseudo number sequence;
means for modulation of the received pseudo number sequence;
means for sending the modulated pseudo number sequence.

21. A transponder according to claim 20, wherein the means for modulation of the received pseudo number sequence further comprises:
means adapted to modulate the received pseudo number sequence by means of delaying the received pseudo number sequence a predetermined delay time from a group of at least two predetermined delay times.

22. A position detection apparatus for a photographic object detection system, comprising:
means for connection of the position detection apparatus to a connectable image capturing apparatus;
means for determining a position of a transponder relative the position detection apparatus;
means for generating transponder data indicative of the position and the identity of the transponder; and
means for generating a signal indicative of the position of the transponder relative an image frame of the image capturing apparatus.

23. A position detection apparatus according to claim 22, further comprising:
a first transmitting means;
a first receiving means;
a first processing means, comprising:
means for generating a pseudo number sequence;
means for decoding the modulated pseudo number sequence;
means for detecting a path time of the pseudo number sequence,
means for detecting a clock correction factor of the transponder by means of the received modulated pseudo number sequence;
means for calculating a flight time of the pseudo number sequence between the position detection apparatus and a transponder by means of the path time, the clock correction factor, and the predetermined delay time of the transponder;
means for calculating the position of said transponder by means of the flight time.

24. A position detection apparatus according to claim 22, wherein the means for generating a pseudo number sequence is a means for generating a pseudo random binary sequence.

25. A position detection apparatus according to claim 22, wherein the means for detecting a path time comprises means for delaying and correlating the generated pseudo number sequence with the received modulated pseudo number sequence, wherein the delay time corresponds to the path time.

26. A position detection apparatus according to claim 22, wherein the first receiving means of the position detection apparatus comprises at least three receiving antennas, and wherein the first processing means further comprises:
means for calculating, for each of the at least three receiving antennas, a distance using said flight time;
means for calculating a position of the transponder, relative the position detection apparatus, using said distance for each of the at least three receiving antennas.
